(19) United States
(12) Patent Application Publication
(10) Pub. No.: US 2015/0091893 A1
(43) Pub. Date: Apr. 2, 2015

(54) USER MODELING METHOD BASED ON USAGE HISTORY OF SMART DEVICE AND APPARATUS USING THE SAME

(71) Applicant: Electronics and Telecommunications Research Institute, Daejeon (KR)

(72) Inventor: Jae Hui PARK, Daejeon (KR)

(73) Assignee: Electronics and Telecommunications Research Institute, Daejeon (KR)

(21) Appl. No.: 14/230,736

(22) Filed: Mar. 31, 2014

(30) Foreign Application Priority Data
Sep. 30, 2013 (KR) 10-2013-0116452

(51) Int. Cl. G06T 19/00

(52) U.S. Cl. CPC G06T 19/00
USPC 345/419

(57) ABSTRACT

Disclosed is a method that performs a user modeling operation based on usage history data of a specific function which is provided or executed by a user terminal, and enables the user modeling result to be applied to various services. The method matches a user with a specific class, based on usage history data of various functions collected by a user terminal, and provides a user-based service suitable for the specific class.

### CROSS-REFERENCE TO RELATED APPLICATIONS

This application claims priority to and the benefit of Korean Patent Application No. 10-2013-0116452, filed on Sep. 30, 2013, the disclosure of which is incorporated herein by reference in its entirety.

### TECHNICAL FIELD

The present invention relates to a user modeling method and an apparatus using the same, and more particularly, to a method and apparatus for modeling a user based on a function usage history of a smart device.

### BACKGROUND

Recently, smart devices provide various functions such as the Internet, an email, a game, a video, photographing, and an execution of a specific application, in addition to phone call and text messages. Smart devices record the presence of use of a corresponding function, based on context information such as a specific time and a specific position.

In the related art, generally, a usage record of a specific function is recorded in a server affiliated with the specific function, and the server performs a user modeling operation or a user analysis operation. However, it is difficult to solve various issues such as a protection of personal privacy, an authentication of a user, and communication between a server and a client, etc.

Moreover, the related art has a limitation in which customized information about a specific function is provided based on a usage record (for example, the frequency number) of use of the specific function. For this reason, there is no multi-dimensional analysis possibility of various function usage records of a user, and a classification of a user type is also limited to some predefined classification types.

### PRIOR ART REFERENCE

### Patent Document

An individualization service providing system using user's feedback and privacy based on user is disclosed in a prior art reference (patent document 0001) “Korean Patent Application No. 10-2011-0128761”. The prior art reference separates and provides profiles by person and a policy for anonymity about a personalization service for personalization and anonymity, causing an increase in a complexity of system construction.

### SUMMARY

Accordingly, the present invention provides a method that performs a user modeling operation based on usage history data of a specific function which is provided or executed by a user terminal, and enables the user modeling result to be applied to various services.

The present invention also provides a method that converts the frequency number of use of a specific function into a distribution value based on a time and a position, and uses the distribution value as a model expressing a user.

The object of the present invention is not limited to the aforesaid, but other objects not described herein will be clearly understood by those skilled in the art from descriptions below.

In one general aspect, a usage history-based user modeling apparatus for generating a user model based on a function provided or executed in a user terminal includes: a data collecting unit configured to collect usage history data including number of executions, an execution time, and an execution position for each of a plurality of functions which are executed in the user terminal; a data analyzing unit configured to quantify the usage history data in a predefined form; and a user modeling unit configured to convert number of executions of one of the plurality of functions, which are executed in the user terminal, into a three-dimensional (3D) vector shape based on an execution time and an execution position.

The usage history-based user modeling apparatus may further include a storage unit configured to store the usage history data, the 3D vector shape, and the predefined form.

The usage history-based user modeling apparatus may further include a user selection input unit configured to receive an input for selecting a function, which is to be monitored, from among the plurality of functions which are executed in the user terminal.

Usage history data of only functions selected through the user selection input unit may be collected and quantified, and the quantified usage history data may be converted into 3D vector shapes.

The user modeling unit may define, as a characteristic model of a user, a set of the 3D vector shapes for the selected functions.

The predefined form may be determined by using a statistical model, such as an average or a variance, or a computing data distribution model such as an information entropy or mutual information.

In another general aspect, a usage history-based user modeling method of generating a user model based on a function provided or executed in a user terminal includes: receiving an input for selecting a function, which is to be monitored, from among a plurality of functions which are executed in the user terminal; collecting usage history data including number of executions, an execution time, and an execution position for each of the selected functions; quantifying the usage history data in a predefined form; and converting number of executions of one of the selected functions into a three-dimensional (3D) vector shape based on an execution time and an execution position.

The collecting of usage history data may include collecting data of number of executions of the selected functions in real time, and collecting data of an execution time and an execution position at certain intervals.

The converting may include defining, as a characteristic model of a user, a set of the 3D vector shapes for the selected functions.

Other features and aspects will be apparent from the following detailed description, the drawings, and the claims.

### BRIEF DESCRIPTION OF THE DRAWINGS

FIG. 1 is a block diagram illustrating a configuration of a user modeling apparatus based on usage history according to an embodiment of the present invention.

FIG. 2 is an exemplary diagram illustrating an example of a user expression model of a specific function which is generated according to an embodiment of the present invention.

FIG. 3 is a flowchart illustrating a user modeling method based on usage history according to another embodiment of the present invention.

FIG. 4 is a diagram illustrating a configuration of a computer apparatus for executing a user modeling method based on usage history according to an embodiment of the present invention.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the following description, the technical terms are used only for explaining a specific exemplary embodiment while not limiting the present invention. The terms of a singular form may include plural forms unless specifically mentioned.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

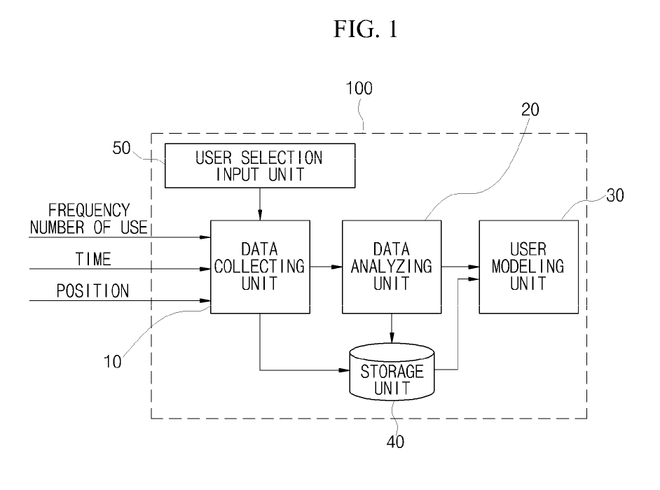

FIG. 1 is a block diagram illustrating a configuration of a user modeling apparatus 100 based on usage history according to an embodiment of the present invention.

Referring to FIG. 1, the user modeling apparatus 100 based on usage history according to an embodiment of the present invention includes a data collecting unit 10, a data analyzing unit 20, a user modeling unit 30, a storage unit 40, and a user selection input unit 50.

The data collecting unit 10 collects usage history data of functions (for example, a telephone function, a text message function, etc. which are fundamentally provided) provided by a user terminal or usage history data of applications executed by the user terminal. Hereinafter, a function provided and an application executed by the user terminal is each referred to as a function.

Here, the usage history data may include information about the number of use, an execution time, an executed time, and an execution position for the functions. To this end, the user modeling apparatus 100 based on usage history according to an embodiment of the present invention may further include a clock generating module, which internally generates time information, and a reception module that receives position information from a global positioning system (GPS) satellite apparatus or an external server.

In an embodiment, the data collecting unit 10 may collect the number of execution of the functions in real time, and collect data of an executed time and an execution position at certain intervals.

In another embodiment, the data collecting unit 10 may collect usage history data of only functions selected by the user selection input unit 50.

To provide a detailed description, a user may select functions, for which monitoring is considered to be necessary, from among a plurality of functions executable by the user terminal. For example, when the user selects an a function, a b function, and a c function by using the user selection input unit 50, the data collecting unit 10 may collect usage history data of only the functions, namely, the a function, the b function, and the c function.

An analysis work of the collected usage history data and a user model generating operation will be described in detail below.

Various kinds of user models may be generated according to a selection result of a function to be monitored. For example, when functions selected by the user selection input unit 50 are the a function, the b function, and the c function, a set of three-dimensional (3D) vector shapes of the selected functions is defined as a characteristic model of a user (hereinafter referred to as a first user model). As another example, when a d function, an e function, and an f function are selected, a set of 3D vector shapes of the selected functions is defined as a characteristic model of a user (hereinafter referred to as a second user model).

As described above, various kinds of user models may be generated according to a selection result of a function to be monitored, and based on the user models, a use pattern of a user is expressed in a synthesis method. The use patter of the user may be applied to various services later.

The data analyzing unit 20 quantifies the usage history data, collected by the data collecting unit 10, in a predefined form. For example, a form for quantifying the usage history data may be stored in the storage unit 40, and the form may be determined by using a statistical model, such as an average or a variance, or a computing data distribution model such as an information entropy or mutual information.

The user modeling unit 30 generates a user model of one of the functions executed by the user terminal, based on the usage history data or the quantified usage history data.

To provide a detailed description, the user modeling unit 30 converts the number of executions of a specific function into a 3D vector shape based on an execution time and an execution position, and defines the 3D vector shape as a user model of the specific function.

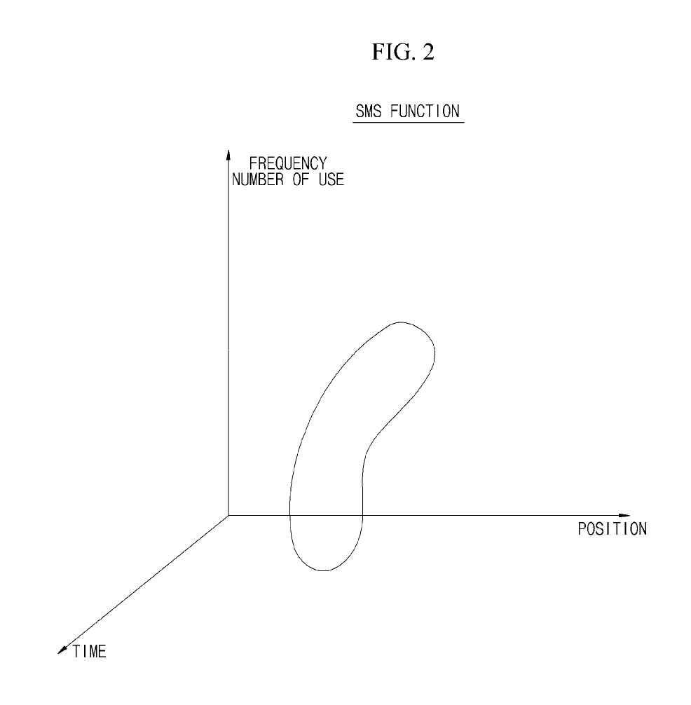

FIG. 2 is an exemplary diagram illustrating an example of a user expression model of a specific function which is generated according to an embodiment of the present invention.

In 3D coordinates shown in FIG. 2, axes respectively indicate a time, a position, and the number of use of a specific function (for example, a text function). A graph, expressed in a corresponding 3D space, is defined as an abstracted shape of a user (hereinafter referred to as a user model) that uses a user terminal.

Here, a time axis indicates a specific time or a set thereof (considering an order), and a dimensional value of a position axis indicates a GPS value corresponding to a specific position or a set thereof (considering an order). A functional axis uses a dimensional value as a normalization value of the frequency number of use of a corresponding function.

Therefore, a graph shape expressed in a 3D coordinate space expresses the frequency number of use of a corresponding function as a 3D vector value, and shows all values of a corresponding expression being listed.

The usage history data, the 3D vector shape, the predefined form, and the quantified usage history data are stored in the storage unit 40.

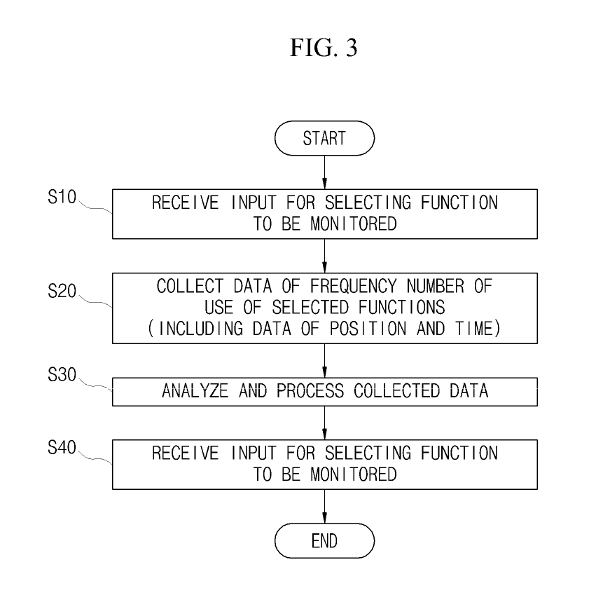

A user modeling method based on usage history according to another embodiment of the present invention will be described in detail with reference to FIG. 3. FIG. 3 is a flowchart illustrating a user modeling method based on usage history according to another embodiment of the present invention.

Referring to FIG. 3, first, a user selects functions to be monitored from among a plurality of functions executable by the user terminal, and the selection result is input through the user selection input unit 50, in operation S10.

Subsequently, the data collecting unit 10 collects usage history data of the selected functions in operation S20. Here, the usage history data may include information about the number of use (execution), an execution time, an executed time, and an execution position for the functions. As described above, the number of execution of the functions may be collected in real time, and data of an executed time and an execution position may be collected at certain intervals.

For example, when the user selects the a function, the b function, and the c function by using the user selection input unit 50, the data collecting unit 10 may collect information about the number of execution, an execution time, an executed time, and an execution position for each of the functions (i.e., the a function, the b function, and the c function) in real time or at certain intervals.

Subsequently, the data analyzing unit 20 analyzes and processes the collected usage history data in operation S30. For example, the data analyzing unit 20 may quantify the collected usage history data in a predefined form. As described above, a form for quantifying the usage history data may be stored in the storage unit 40, and the form may be determined by using a statistical model, such as an average or a variance, or a computing data distribution model such as an information entropy or mutual information.

Subsequently, the user modeling unit 30 generates a user model of one of the functions executed by the user terminal, based on the usage history data or the quantified usage history data in operation S40.

To provide a detailed description, the user modeling unit 30 converts the number of executions of a specific function into a 3D vector shape based on an execution time and an execution position, and defines the 3D vector shape as a user model of the specific function.

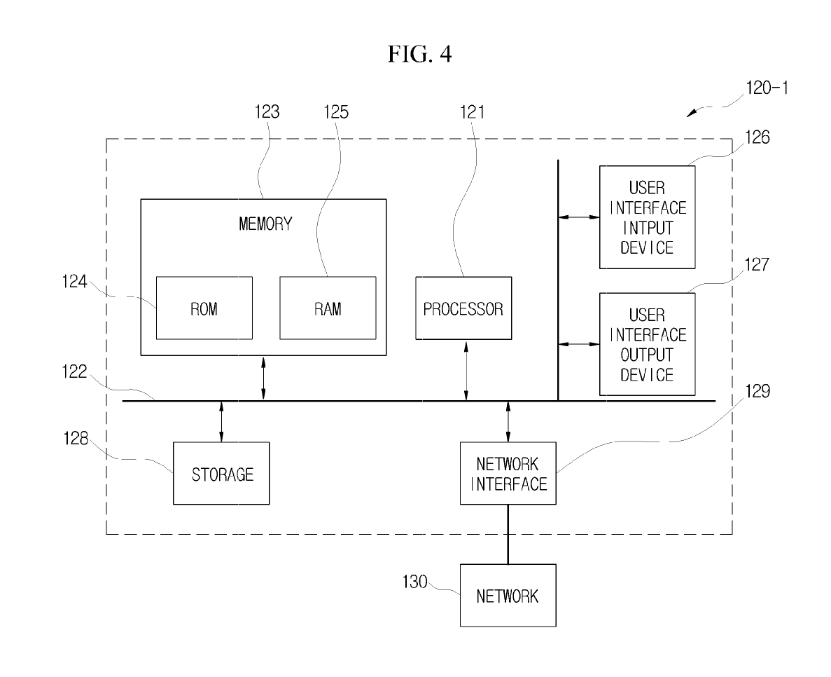

The user modeling method based on usage history of a smart device according to an embodiment of the present invention may be implemented in a computer system, or may be recorded in a recording medium. As illustrated in FIG. 4, the computer system may include at least one or more processors 121, a memory 123, a user interface input device 126, a data communication bus 122, a user interface output device 127, and a storage 128. The elements perform data communication through the data communication bus 122.

The computer system may further include a network interface 129 coupled to a network. Each of the processors 121 may be a central processing unit (CPU) or a semiconductor device that processes a command stored in the memory 123 and/or the storage 128.

The memory 123 and the storage 128 may include various types of volatile storage mediums or nonvolatile storage mediums. For example, the memory 123 may include a read-only memory (ROM) 124 and a random access memory (RAM) 125.

Therefore, the user modeling method based on usage history of a smart device according to an embodiment of the present invention may be implemented as a method executable by a computer. When the user modeling method based on usage history of a smart device according to an embodiment of the present invention is performed in a computer apparatus, computer-readable commands may perform a recognition method according to the present invention.

The user modeling method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

As described above, the present invention matches a user with a specific class, based on usage history data of various functions collected by a user terminal, and provides a user-based service suitable for the specific class. For example, when a provider that develops and provides a photographing application desires to provide an user-based advertisement, the present invention helps the provider perform a decision making process in which the advertising effect is higher when an advertisement is intensively exposed to a user (who constantly uses a photographing function at a certain time and place) than a user who intensively uses the photographing function at a specific time and place.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A usage history-based user modeling apparatus for generating a user model based on a function provided or executed in a user terminal, the usage history-based user modeling apparatus comprising:
a data collecting unit configured to collect usage history data including number of executions, an execution time, and an execution position for each of a plurality of functions which are executed in the user terminal;
a data analyzing unit configured to quantify the usage history data in a predefined form; and
a user modeling unit configured to convert number of executions of one of the plurality of functions, which are executed in the user terminal, into a three-dimensional (3D) vector shape based on an execution time and an execution position.

2. The usage history-based user modeling apparatus of claim 1, further comprising a storage unit configured to store the usage history data, the 3D vector shape, and the predefined form.

3. The usage history-based user modeling apparatus of claim 1, further comprising a user selection input unit configured to receive an input for selecting a function, which is to be monitored, from among the plurality of functions which are executed in the user terminal.

4. The usage history-based user modeling apparatus of claim 3, wherein usage history data of only functions selected through the user selection input unit are collected and quantified, and the quantified usage history data are converted into 3D vector shapes.

5. The usage history-based user modeling apparatus of claim 4, wherein the user modeling unit defines, as a characteristic model of a user, a set of the 3D vector shapes for the selected functions.

6. The usage history-based user modeling apparatus of claim 1, wherein the predefined form is determined by using a statistical model, such as an average or a variance, or a computing data distribution model such as an information entropy or mutual information.

7. A usage history-based user modeling method of generating a user model based on a function provided or executed in a user terminal, the usage history-based user modeling method comprising:
receiving an input for selecting a function, which is to be monitored, from among a plurality of functions which are executed in the user terminal;
collecting usage history data including number of executions, an execution time, and an execution position for each of the selected functions;
quantifying the usage history data in a predefined form; and
converting number of executions of one of the selected functions into a three-dimensional (3D) vector shape based on an execution time and an execution position.

8. The usage history-based user modeling method of claim 7, wherein the collecting of usage history data comprise collecting data of number of executions of the selected functions in real time, and collecting data of an execution time and an execution position at certain intervals.

9. The usage history-based user modeling method of claim 7, wherein the converting comprises defining, as a characteristic model of a user, a set of the 3D vector shapes for the selected functions.
